(19) United States
(12) Patent Application Publication
(10) Pub. No.: US 2006/0108744 A1
(43) Pub. Date: May 25, 2006

(54) Self-adjusting gap seal between two movable components

(76) Inventor: Reinhard Raueiser, Muden (DE)

Correspondence Address: WILLIAM COLLARD;COLLARD & ROE, P.C., 1077 NORTHERN BOULEVARD, ROSLYN, NY, 11576, US

(21) Appl. No.: 11/228,654

(22) Filed: Sep. 16, 2005

(30) Foreign Application Priority Data
Sep. 16, 2004 (DE) 10 2004 044 803.5

(51) Int. Cl. F16J 15/16

(52) U.S. Cl. 277/345

(57) ABSTRACT

A device for adjusting a gap seal between two components that move relative to one another, as well as a method in this regard. The device brings two parallel sealing surfaces onto one another without a gap, before the first-time movement, and adjusts the gap to the smallest possible dimension in the start-up phase of the movement, by means of targeted wear of one sealing surface itself.

### BACKGROUND OF THE INVENTION

1. Field of the Invention

The present invention relates to a gap seal system having an automatic adjustment of the gap between a resting component and a moving component, or components that move relative to one another. The components form a common cavity for transfer of a medium between a control valve and a vacuum roller for transporting cut-outs via vacuum.

2. The Prior Art

It is generally known that two components that move relative to one another, which form a common cavity, are sealed relative to their surroundings by means of a gap seal, without contact. In this connection, a leakage current flows through the gap.

In envelope-producing machines, this technology is used at many locations in the production process to supply a vacuum roller for transporting envelope cutouts or material webs with vacuum. The vacuum roller, which is mounted in a machine frame, is supplied with vacuum by a control valve mounted on the roller axle. The control valve is axially displaceable to adjust the gap between vacuum roller and control valve, and radially displaceable to adjust the bezel position.

To adjust the gap, the disk cam is moved on the axle, using an adjustment nut that can be fixed in place towards the face of the vacuum roller, against a spring package, until the smallest possible gap is adjusted. Subsequently, the control valve is fixed in place axially and radially relative to the machine frame. The gap width must be checked using a gage, and must not be too small, so that seizing of the sealing surfaces is precluded.

The vacuum runs to the vacuum air channels that lie crosswise in the vacuum roller by way of the disk cam, and from there to the vacuum air openings that are distributed on the circumference, in accordance with the requirements, in each instance.

By configuring the control valve, the vacuum roller can also be provided with vacuum section by section, or also can supply certain sections with blowing air, by means of a second chamber in the disk cam.

A great disadvantage of this device is the enormous variety of parts, the installation and adjustment effort, as well as the required construction space for the bearing and the adjustment device of the control valve.

### SUMMARY OF THE INVENTION

It is therefore an object of the present invention to create a device as well as a method for minimizing the seal gap, the space requirement, the variety of parts, and the installation and adjustment effort, which device/method is inexpensive to produce, operate and maintain.

One embodiment of the device according to the invention has a control valve that supplies the vacuum air bores at the circumference of a vacuum roller with vacuum and/or compressed air, by way of the cross-bores in the vacuum roller, and of an adjustment device.

A disk cam is preferably still affixed to the vacuum roller that is mounted to rotate in the machine frame, in order to be able to utilize the vacuum roller for different format settings.

According to the invention, the control valve is rigidly attached to the machine frame and structured in such a manner that it is able to supply the vacuum roller with vacuum and/or compressed air over a specific angle range, by means of the disk cam. The disk cam can consist of several partial segments, with at least one connection for vacuum or compressed air, in each instance.

To achieve the automatic adjustment of the gap seal according to the invention, the two parallel sealing surfaces of the vacuum roller, or of the vacuum roller with the disk cam, and of the control valve, are pressed against one another and fixed in place, by means of the adjustment device, with the desired force.

The adjustment takes place via an adjustable adjustment nut on the axle, which can be fixed in place and can move the axle mounted in the machine frame, with the vacuum roller attached to it, axially against a spring package. Alternatively, the vacuum roller may be fixed in place in its position, and the disk cam may be movable, so that it can be adjusted and fixed in place relative to the frame, for example by way of tension/pressure screws.

In order for a seal gap to occur, one of the sealing surfaces has a hard and rough surface, preferably the sealing surfaces of the vacuum roller, and the other consists of a material that can be worked by the hard, rough surface. The hard, rough surface can be, for example, a coating, or the roughness can be produced by sand-blasting. Graphite or plastic, for example, can be used as the counter-material. It is particularly advantageous if the disk cam itself does not consist of the counter-material, but rather is equipped with an interchangeable sealing surface.

With the start of the rotational movement, working of the soft sealing surface takes place. The gap is produced, which is precisely wide enough that there is no longer any contact between the sealing surfaces. The chips that are formed in this connection are removed by the vacuum.

By selection of the surface roughness and the profiling of the working sealing surface, a labyrinth seal effect can advantageously be achieved, in order to minimize the leakage current.

Alternatively, the hard sealing surface may be smooth and the soft sealing surface may be rough, so that when the vacuum roller starts up, the peaks of the soft sealing surface wear down, until there is no longer any contact.

Another advantage of the device is the protection against seizing, if the components expand because they have been overheated, because only the seal gap increases and this can subsequently be readjusted again in a simple manner.

The decision as to the side on which the working surface is applied is only dependent on the task and on the available construction space.

The method of functioning and the control of the individual vacuum air openings for applying vacuum by means of valve channels and passage channels disposed within the roller body will not be discussed, since this is usual in the present field and familiar to a person skilled in the art. It should merely be noted that the vacuum air openings in the mantle surfaces of the individual roller bodies can be selectively impacted with vacuum as the latter rotate. Linear devices are also possible within the scope of the invention.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a side view of one embodiment of the device according to the invention;

FIG. 2 shows a control valve according to an embodiment of the invention; and

FIG. 3 shows a configuration example for the sealing surface according to the invention;

### DETAILED DESCRIPTION OF THE PREFERRED EMBODIMENT

The embodiment of the device according to the invention, for producing a self-adjusting gap seal, described below, can be used, for example, for the vacuum supply (6) of vacuum rollers (1) for the transport of a cutout as they are used in the production of envelopes.

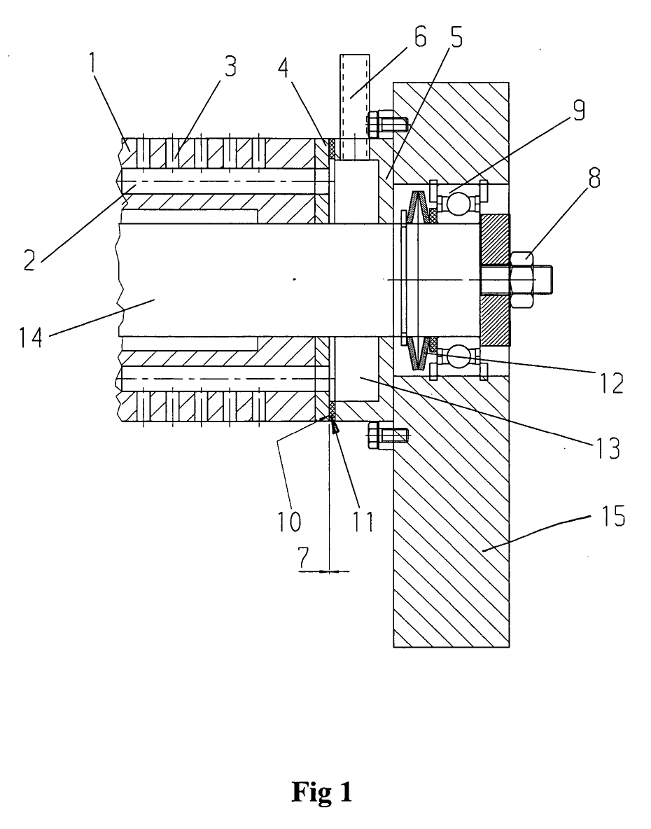

FIG. 1 shows one embodiment of the device according to the invention in a side view. In this embodiment, disk cam 4 is attached to vacuum roller 1. Disc cam 4 former possesses a hard, rough sealing surface 10 that can work a material that wears easily, for example graphite. Disk cam 4 has a bore image that is coordinated with the desired application, so that only the desired part of vacuum bores 3, in each instance, is connected with vacuum 6 by way of cross-bores 2 in vacuum roller 1. Vacuum roller 1 with disk cam 4 attached to it is mounted in the machine frame so as to rotate and be axially displaceable.

Control valve 5 is rigidly connected with the machine frame. The sealing surface of control valve 5 consists of a material that wears easily, such as graphite, for example.

The hard, rough sealing surface 10 of disk cam 4 is brought into contact with sealing surface 11 of control valve 5 by means of the adjustment device that consists of adjustment nut 8 on axle 14 and spring package 12. This takes place before start-up of vacuum roller 1, whereby contact pressure is selected in accordance with the desired amount of wear.

When vacuum roller 1 with disk cam 4 attached to it is put into motion, sealing surface 10 of disk cam 4 grinds sealing surface 11 of control valve 5 down to a point that there is no longer any contact between sealing surfaces 10, 11, and therefore the smallest possible gap dimension has been formed. The chips that are formed in this connection are vacuumed away by vacuum 6.

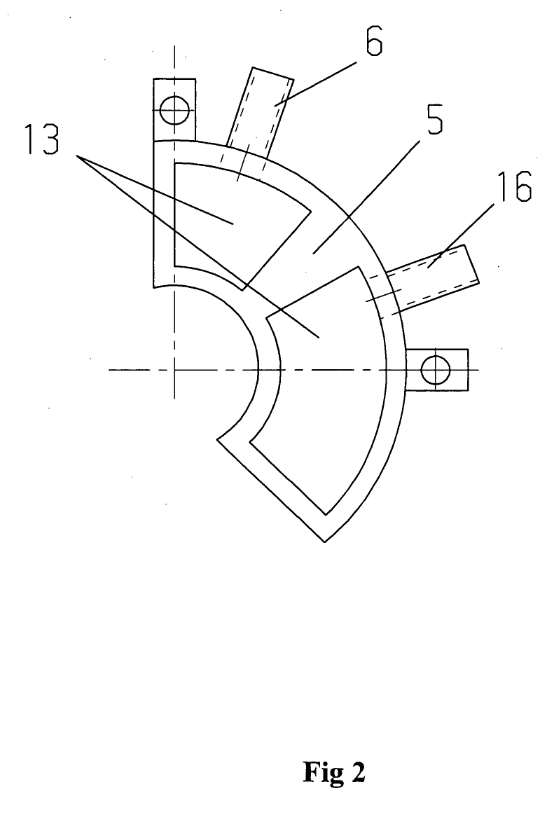

FIG. 2 shows a control valve 5 in an exemplary embodiment. Control valve 5 has two segment sections that can be supplied with vacuum 6 or compressed air, independently of one another.

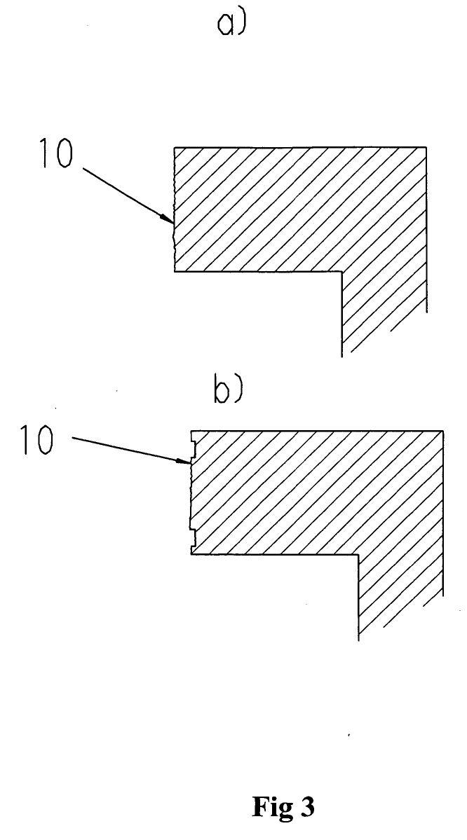

FIG. 3 shows possible embodiments of the working sealing surface, as examples:
a) sand-blasted sealing surface,
b) sealing surface with coating 13 and contour for producing a labyrinth seal.

Accordingly, while only a few embodiments of the present invention have been shown and described, it is obvious that many changes and modifications may be made thereunto without departing from the spirit and scope of the invention.

### REFERENCE SYMBOL LIST

1 vacuum roller
2 cross-bores
3 vacuum bores
4 disk cam
5 control valve
6 vacuum
7 gap dimension
8 adjustment nut
9 bearing
10 hard sealing surface
11 soft sealing surface
12 spring package
13 vacuum/pressure chamber
14 axle
15 frame

What is claimed is:

1. An arrangement for forming a contact-free gap seal between parallel sealing surfaces of a component that rests during operation, and a component that rotates about an axle, or components that rotate relative to one another, for transferring a vacuum or compressed air, comprising:
a first sealing surface on a first one of said components, said first sealing surface being wear-resistant; and
a second sealing surface on a second one of said components, said second sealing surface being worn by contact with the wear-resistant surface, and forms a labyrinth-like structure that is continuous and extends over the entire second sealing surface; wherein said first and second sealing surfaces follow one another in an axial direction; and
a device for adjusting the gap between the first and second sealing surfaces after the second sealing surface has been worn by the first sealing surface.

2. An arrangement according to claim 1, wherein the device for adjusting the gap comprises at least one control valve and one adjustment device.

3. An arrangement according to claim 1, wherein at least one of the sealing surfaces has a rough surface.

4. An arrangement according to claim 2, wherein the rough sealing surface is configured so that a labyrinth seal is produced in the gap.

5. An arrangement according to claim 1, wherein the control valve has at least one vacuum or pressure chamber.

6. An arrangement according to claim 1, further comprising an adjustment nut that is fixed in place against a spring package, for adjusting the sealing surfaces relative to one another by axial displacement of an axle that is mounted to rotate in a machine frame, and of a vacuum roller that is attached to said axle.

7. An arrangement according to claim 8, wherein the vacuum roller is fixed in a position, and the control valve is movable and can be adjusted by way of tension or pressure screws, relative to the machine frame, and then fixed in place.

8. An arrangement according to claim 1, wherein at least one of the sealing surfaces is configured as a labyrinth.

9. A method for automatically producing a contact-free gap seal between the parallel sealing surfaces of a resting component and a moving component, or components that move relative to one another, for transferring a vacuum or compressed air, comprising:
bringing the sealing surfaces onto one another without a gap;
fixing said surfaces in place relative to one another; and
moving the sealing surfaces relative to each other until one of the two surfaces is worn down, to create a gap between the sealing surfaces.

10. Method according to claim 9, wherein the gap has a lowest possible gap dimension after said one of said two surfaces has been worn down.

11. Method according to claim 9, wherein the size of the gap that is formed is determined by displacement and fixation of an axle together with a vacuum roller.

12. Method according to claim 9, further comprising the step of displacing and fixing a control valve to regulate the gap.

13. Method according to claim 9, wherein the gap, which becomes smaller due to expansion of components containing the sealing surfaces as they warm up, automatically grinds itself free again.
